(19) United States
(12) Patent Application Publication
(10) Pub. No.: US 2010/0230971 A1
(43) Pub. Date: Sep. 16, 2010

(54) Mooring System for Tidal Stream and Ocean Current Turbines

(76) Inventor: Graeme Charles Mackie, Tyne & Wear (GB)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 12/663,033

(22) PCT Filed: May 20, 2008
(86) PCT No.: PCT/GB08/50363

§ 371 Date: Mar. 23, 2010

(30) Foreign Application Priority Data
Jun. 5, 2007 (GB) 0710822.8

(51) Int. Cl. F03B 13/10

(52) U.S. Cl. 290/54

(57) ABSTRACT

A tidal stream or ocean current turbine is connected to a submerged buoy that is tethered to the seabed to create a virtual seabed level that is higher than the actual seabed. The buoy is constrained by tensioned tethers or catenary mooring lines such that it is approximately geofixed at a prescribed depth of immersion and orientation. The turbine device is attached to the submerged buoy by a connector strut that allows the device to swivel about the geofixed location. The strut to buoy connection incorporates a bearing system that allows the strut freedom of rotation in the horizontal and vertical planes about the geofixed buoy. The reserve of buoyancy in the submerged buoy acts to resist the vertical component of the mooring force such that the drag force on the turbine device cannot lead the device to submerge excessively or cause the downstream tension tether mooring lines to go slack.

### FIELD OF THE INVENTION

The present invention relates to the extraction of energy from tidal streams and ocean currents by means of a turbine, and in particular to a mooring system for such a turbine.

### BACKGROUND OF THE INVENTION

Tidal streams and ocean current can be used to generate power by placing a horizontal or vertical axis turbine in the flow. For deep water tidal stream and ocean current sites the turbine can be supported by buoyancy and tethered to the seabed by a mooring system.

Horizontal or vertical axis turbines used to extract energy from the kinetic energy within a moving body of water experience high drag forces as a by-product of the energy extraction process. If a device fitted with a turbine (1) is moored off to the seabed the mooring line (2), which is subject to a large horizontal drag force F_{D} generated by the turbine, must apply a tension force T to the device which can be resolved into a horizontal force F_{H} which is equal and opposite to F_{D} and a vertical force F_{V} as shown in FIG. 1. This vertical downward acting component of mooring force needs to be balanced by an equal and opposite vertical upward acting force for the device to achieve an equilibrium position in the water column otherwise the device will descend deeper in the water with the risk that the turbine will impact on the seabed.

Solutions have been proposed for resisting the vertical downward acting force including:
a) Designing the device to float on the water surface such that the excess buoyancy of the device can be used to resist the vertical component of the mooring force (for example, the devices described in published patent application numbers WO 88/04362 and EP 1467091 A1). This has the disadvantage that the surface floating device experiences motions induced by surface waves to the detriment of the performance of the turbine or turbines that are attached to the device.
b) Attaching a surface floating buoy to the submerged device to resist the vertical component of the mooring force (for example, the device described in published patent application number UK Patent GB 2256011 B). This has the disadvantage that the buoy experiences wave induced motions that are transmitted to the turbine device to the detriment of the turbine performance.
c) Providing the submerged device with sufficient buoyancy to resist the vertical component of mooring force under the most extreme current drag force to prevent the device grounding on the seabed (for example, the devices described in published patent application numbers WO 03/025385 A2 and WO 03/056169). This solution has the disadvantage that active means of ballasting will be required to prevent the device exerting too high a buoyant up-thrust when the current drag force is reduced.
d) Providing the submerged device with streamline surface piercing buoyant struts that are progressively submerged under the influence of the vertical component of mooring force to provide additional buoyancy force until an equilibrium level of immersion is reached where the buoyancy force equals the vertical component of mooring force (for example, the device described in published patent number GB 2422878).
e) Providing the submerged device with hydrofoils that generate a hydrodynamic lift force in a flowing current to counteract the vertical component of the mooring force (for example, the device described in published patent application number DE 2933907 A1). The hydrofoil solution has the disadvantage that it applies additional drag force to the mooring and cannot be guaranteed to always exert a vertical up-thrust as with buoyancy force.
f) Providing a turbine which is positively buoyant and which is pivotally attached to a mooring arrangement so that the turbine will move in an arc between positions in which drag forces on the turbine cause said turbine to lie low in the body of water, and a position under conditions of little or no flow in the body of water where the turbine lies at or near the surface of the body of water (such an arrangement being described in WO 04083629). This arrangement presents a number of problems. First, because the turbine must be able to move in an arc about its attachment to the mooring arrangement, the turbine must be sited in relatively deep water. Second, when the turbine is in its vertical position, it is subject to wave action and hence significant snatch loads. Also, because the centres of buoyancy and gravity must be separated for the device to change from a horizontal attitude in fast flow to a vertical attitude in slack flow then in intermediate flow conditions the device will not be optimally aligned with the flow to the detriment of turbine efficiency.

However, all the above-mentioned solutions suffer from at least one disadvantage.

It would therefore be desirable to provide a mooring system which alleviates at least some of the disadvantages associated with the solutions of the prior art.

The invention therefore relates to a mooring system to moor a buoyant submerged or floating tidal stream or ocean current energy conversion device, henceforth referred to as the device, such that the device is kept off the seabed and has a means for exporting the power generated. Advantageously, the mooring system provides that the device is free to weathervane with respect to the mooring system.

### SUMMARY OF THE INVENTION

According to the invention there is provided a turbine mooring system comprising a submerged buoyant body tethered to the seabed, wherein the turbine is moored to the submerged buoyant body.

Preferably, the submerged buoyant body, also referred to as the submerged buoy, is tethered and occupies a substantially fixed position with respect to the seabed, thereby creating a virtual seabed level that is higher than the actual seabed.

Preferably, the submerged buoyant body is constrained by mooring elements, such as tensioned tethers or catenary mooring lines.

The turbine device may be attached to the submerged buoyant body by a connector that allows the device to swivel with respect to the submerged buoyant body. Preferably, the attachment of the device to the buoyant body provides for the device to rotate 360 degrees about the buoyant body. The connector may be in the form of a strut or struts. The connector to buoyant body connection preferably incorporates a bearing system that allows the connector freedom of rotation in the horizontal and vertical planes about the buoyant body.

Advantageously, the submerged buoyant body is moored such that it occupies a substantially geofixed location.

Preferably, the buoyant body is substantially geofixed at a prescribed depth of immersion. The buoyant body may be fixed at a prescribed orientation.

One advantage of providing a mooring system which allows the device to swivel about the geofixed position is that the device may align itself with the prevailing current direction.

The buoyant body preferably includes a reserve of buoyancy which acts to resist the vertical component of the mooring force such that the drag force on the turbine device cannot lead the device to submerge excessively or, if tension tethers are deployed to moor the buoyant body to the seabed, cause the downstream tension tether mooring lines to go slack.

By mooring the device to a submerged buoyant body which sits above the sea bed, the amount of buoyancy in the device may be reduced without risk of the turbine impacting the seabed. Reducing the buoyancy of the device results in the device being affected less by wave action as the magnitude of wave excitation forces on the device is reduced.

The mooring lines as illustrated in FIGS. 4 to 13b may be pre-tensioned. The advantage of pre-tensioning the mooring lines is that the excursion of the turbine from its anchor point may be reduced. This is particularly advantageous for an arrangement of multiple turbines in a locality. Using the mooring system of the present invention the distance between such turbines may be reduced as compared to the prior art.

Further, where the buoyant body is moored by at least two mooring lines attached to the seabed at spaced apart locations as illustrated in FIG. 4, the amount of reserve buoyancy in the body may be increased compared to the situation where the body is moored by a single mooring line. Mooring by at least two mooring lines limits the vertical and horizontal extent of movement of the buoyant body relative to the seabed when subject to loads of varying magnitude and direction from the attached turbine device.

Another advantage of the mooring system of the present invention is that, by placing a substantial element of the overall buoyant upthrust from the system (turbine device plus submerged buoy) into the spread moored buoy, the angle of inclination of the mooring lines with respect to the sea bed may be greater than is the case with mooring systems of the prior art, thus enabling the submerged buoy to be positioned higher in the water column where the current speeds are generally stronger. This is because the greater vertical force imparted into the mooring lines by the submerged buoy ensures that the resultant force vector from the combination of horizontal turbine drag and vertical buoyancy force does not lead to the downstream mooring lines going slack when a tension tethered mooring system is deployed.

Where the buoyant body is moored such that it occupies a substantially geofixed position the device may rotate about that position and hence align itself with the prevailing current, without requiring a large sea area for the excursions of the device, compared for instance to the sea area required by the arrangements illustrated in FIGS. 1, 2 and 3, where the turbine would align itself with the prevailing current (8) by rotating the full length of the mooring line (2) and (12) about the single seabed anchor point. Further, where the mooring lines are attached to the buoyant body rather than directly to the device, the risk of the turbine blades fouling the elements of the mooring system is reduced.

The buoyant body may comprise a buoyant element and a support. The support is advantageously attached to the mooring elements and the device to the buoyant element. Preferably the buoyant element is mounted on the support so as to swivel thereabout. Such an arrangement allows the buoyant element to be streamlined in the direction of current. This is because where the buoyant element is mounted on the support so as to swivel thereabout the buoyant element will align itself with the prevailing current. Streamlining of the buoyant element allows the drag thereby to be reduced compared to that experienced by a geometrically symmetrical buoyant element.

### BRIEF DESCRIPTION OF THE DRAWINGS

In the drawings, which illustrate both examples of mooring systems of the prior art and mooring systems of the invention:

FIG. 1 is a schematic representation of a mooring system of the prior art;

FIG. 2 is a schematic representation of the mooring system of FIG. 1 showing the turbine position when subjected to forces F_{D1} (the mooring line shown in broken lines) and F_{D2}.

FIG. 3 is a schematic representation of a mooring system according to a first embodiment of the invention;

FIG. 4 is a schematic representation of a mooring system according to a second embodiment of the invention;

FIG. 5 is a plan view of a mooring system according to a third embodiment of the invention;

FIG. 6 is a side view of a mooring system of the type illustrated in FIG. 5 in which tension tethers have been replaced by catenary mooring lines;

FIG. 7 is a schematic representation of the invention illustrating the position occupied by a floating turbine device at high and low tides;

FIGS. 8a to 8c illustrate the possible six degree of freedom motions experienced by a turbine moored using a mooring system as illustrated in FIG. 5 or 6 when the turbine is subjected to wave motion, FIG. 8a being a plan view, FIG. 8b being a side view and FIG. 8c being an end view;

FIGS. 9a and 9b are schematic representations of a mooring system according to a fourth embodiment of the invention, FIG. 9a being a side view and FIG. 9b being a plan view;

FIGS. 10a and 10b are schematic representations of a mooring system according to a fifth embodiment of the invention, FIG. 10a being a side view and FIG. 10b being a plan view;

FIG. 11 illustrates a power connection to a turbine moored by a mooring system according to the invention;

FIG. 12 illustrates the retrieval of a buoyant body of a mooring system according to the invention; and

FIGS. 13a and 13b illustrate a sixth embodiment of the invention.

### DETAILED DESCRIPTION OF THE EMBODIMENT OF THE INVENTION

While various solutions for resisting the vertical downwards acting force induced by a seabed tethered turbine device are described in the Background to the Invention, the invention described hereunder relates to use of a submerged buoyant body to resist the mooring tension induced downwards force. In this arrangement, the buoyancy required to maintain the mooring system in the desired configuration can be provided by the buoyancy in the submerged buoyant body. At a minimum, the turbine need only be neutrally or marginally positively buoyant.

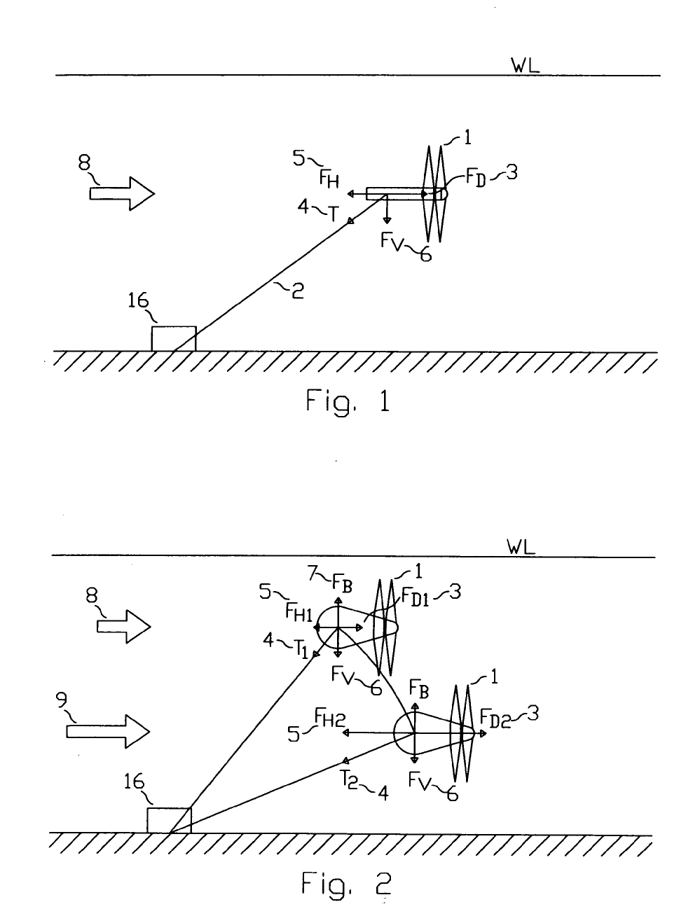

FIG. 1 illustrates the basic concept of a submerged turbine device with twin counter-rotating turbines (1) tethered by a mooring line (2) which is fixed at one end to the seabed by an anchor (16). The forces acting on the mooring line used to constrain a horizontal axis turbine device placed in a flow of water in a mooring system of the prior art are illustrated. The turbine device which is assumed to be neutrally buoyant experiences a horizontal drag force F_{D} (3) when placed in a current (8). This must be resisted by the mooring tether through tension T in the mooring line (4). The tension force T can be resolved into horizontal force component F_{H} (5) and vertical component F_{V} (6). The situation described in FIG. 1 where the vertical component of mooring restraint F_{V} drags the body lower in the water will, if not resisted, lead to the turbine descending in the water column until it impacts on the seabed.

FIG. 2 shows how introducing bet buoyancy into the turbine device enables an equilibrium position to be reached that avoids the turbine impacting on the seabed in a mooring system of the prior art. The vertical downwards force F_{V} is counteracted by introducing buoyancy into the turbine device such that at the maximum experienced current speed the resolved vertical component of the restraint from the mooring tether F_{V} (6) is balanced by the reserve buoyancy force F_{B} (7) as shown in FIG. 2. With this solution the turbine device will ascend and descend in the water column according to the magnitude of the drag force on the turbine which is directly proportional to square of the current speed until the vertical force F_{V} balances the constant buoyancy force F_{B}. FIG. 2 shows how at a low current speed (8) the turbine device will float high in the water column while at high current speed (9) the turbine device will float lower in the water column. Provided there is sufficient buoyancy built into the turbine device to cope with the maximum current drag force the device will not impact on the seabed.

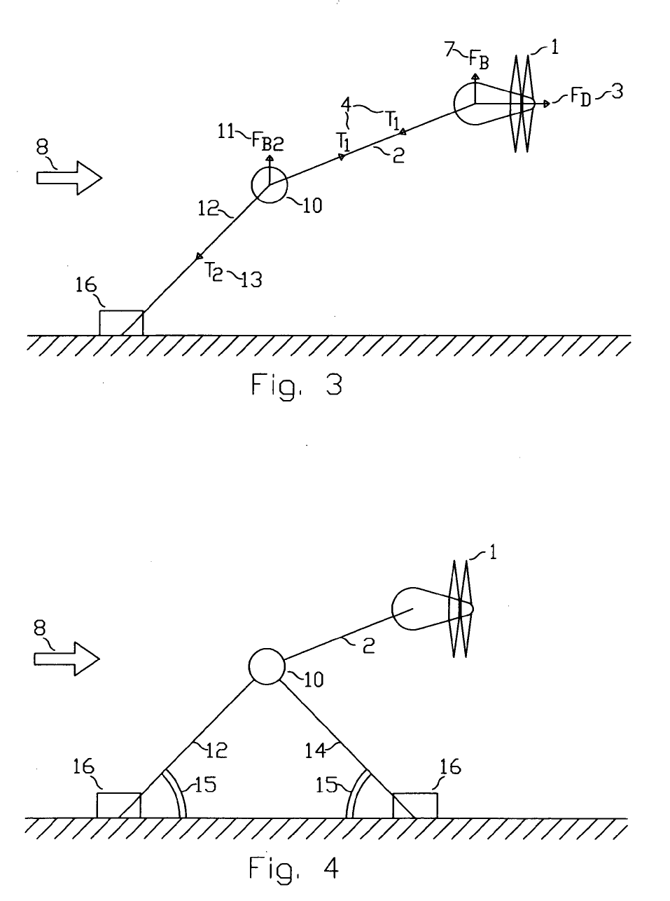

FIG. 3 shows how the introduction of additional buoyancy into the mooring line can be used to reduce the dynamic immersion of the device. By introducing a submerged buoy (10) into the mooring tether it is possible to assist the buoyancy of the turbine device in resisting the vertical component of the mooring restraint (FIG. 3). The reserve of buoyancy (the difference between its weight and buoyancy) introduces an additional upward force F_{B2} (11) which helps to keep the turbine device (1) off the seabed but increases the load T₂ (13) in the submerged buoy mooring tether (12).

FIG. 4 shows an embodiment of the invention where the additional buoyancy is constrained from vertical movement by a second mooring line such that the reserve of buoyancy in the buoy can be increased. Where a second tether (14) is attached to the submerged buoy as shown in FIG. 4 it is possible to constrain the position of the buoy so that the turbine device is moored off to a point that is fixed vertically in the water column above the seabed level. This acts to limit the excursions of the turbine device as the current speed changes. For this scheme to work, it is necessary for the reserve of buoyancy in the submerged buoy (the difference between its weight and buoyancy) to be sufficient to maintain tension in the downstream mooring line. By increasing the reserve of buoyancy it is possible to increase the subtended angle of the mooring lines with the seabed (15) without significantly increasing the tension in the mooring lines.

FIG. 5 shows how applying multiple mooring lines in a spread mooring configuration provides the submerged buoy with a geofixed location so that the turbine device now weathervanes about the geofixed buoy with reduced excursions.

The plan view of the mooring arrangement given in FIG. 5 shows two submerged buoys (10), each buoy being restrained in a geofixed location by two upstream (12) and two downstream (14) mooring lines. A turbine device (1) is tethered off to each buoy and is free to weathervane about the fixed buoy. This gives the buoy a geofixed location such that the turbine device can weathervane about the buoy with reduced mooring excursions compared to the solution shown in FIGS. 2 and 3. This is an important characteristic when multiple turbine devices are to be deployed in a “farm” configuration as it reduces the overall seabed footprint of the multi-device farm.

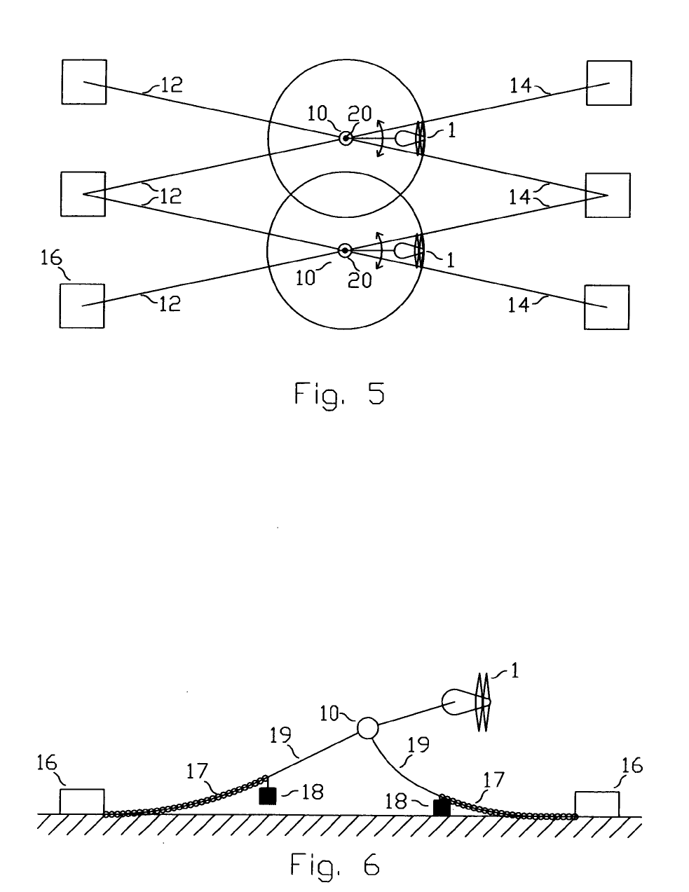

FIG. 6 shows how the spread mooring configuration can be arranged with catenary mooring lines in place of tension tethers.

This allows the mooring system to better absorb current and wave induced snatch loads on the mooring system. In addition a catenary mooring system can be designed such that the seabed anchors only see horizontal load and do not experience any uplift forces which simplifies anchoring arrangements. The catenary mooring system for the submerged buoy will consist of heavier wire rope or chain (17) on the lower section of the mooring tether, possibly augmented by clump weights (18) but with the option of lighter chain, wire or synthetic rope (19) for the upper length of the mooring tether to reduce the weight of the mooring supported by the buoy. It may also be beneficial to pre-tension the catenary mooring lines to limit the excursions of the submerged buoy when subjected to the drag load of the turbine device.

A moored turbine device operating in a tidal stream will experience directions of flow that change with the tidal cycle. Allowing the turbine device to weathervane around the geofixed buoy will ensure that it is always aligned with the flow for optimum turbine performance. This requires that the turbine device is attached to the geofixed buoy by a swivel (20) which must provide freedom of rotation at the geofixed buoy end of the connection (see FIG. 5).

FIG. 7 shows how the system can be applied to a semi-submerged floating turbine device such that the device can move up and down relative to the seabed according to the tide level.

Additionally a submerged turbine device will rise and fall in the water column according the drag on the turbine and, if the turbine device is semi-submerged with a surface piercing strut (21), the change in water depth between high water (22) and low water (23) will lead to a change in the angle of the applied drag force on the submerged buoy. The mooring connection between the submerged buoy and the turbine device must allow for this change in the angle of the mooring connector in the vertical plane (24) as shown in FIG. 7.

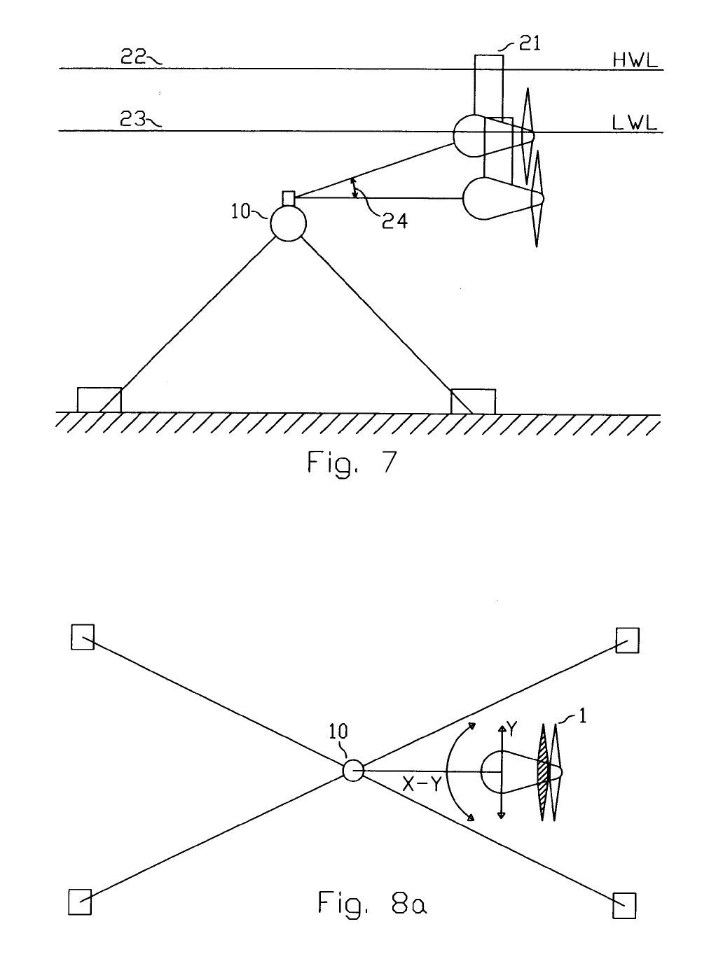

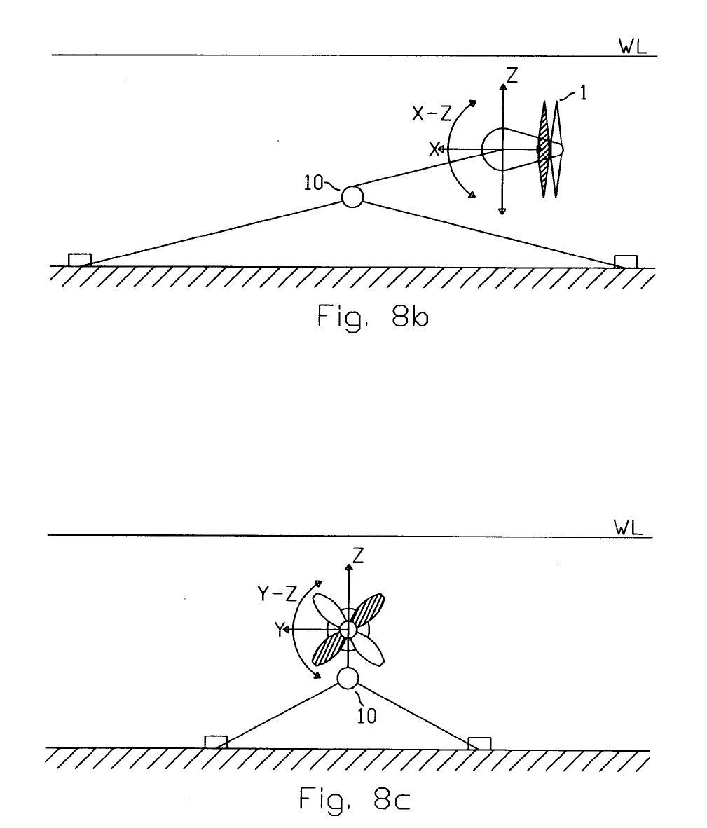

FIGS. 8a to 8c show the possible six degree of freedom motions experienced by a turbine device if subject to wave action.

Additionally the turbine device, unless deeply submerged, will experience wave induced motions surge (x), sway (y), heave (z), yaw (x-y), pitch (x-z) and roll (y-z) that have to be accommodated by the mooring connector to the geofixed buoy (FIG. 8). One possible mooring connector is a chain, wire or rope strop tether.

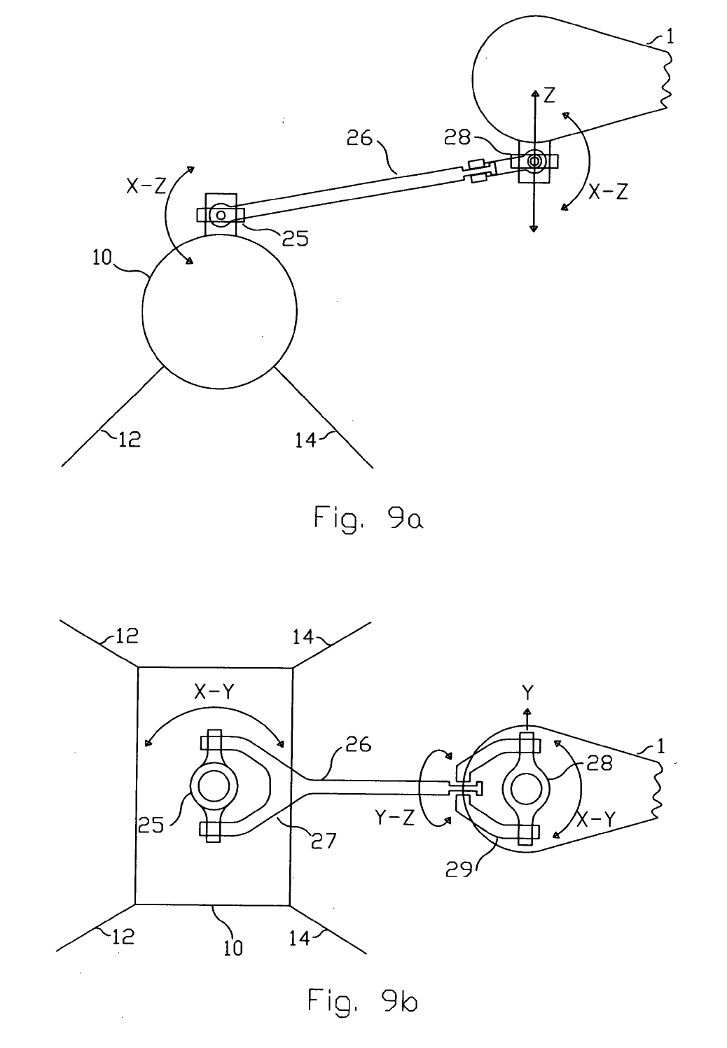

FIGS. 9a and 9b show the pivot connections required in a strut linking the turbine device to the submerged geofixed buoy to cope with the required degrees of freedom of motion without transmitting moments through the strut.

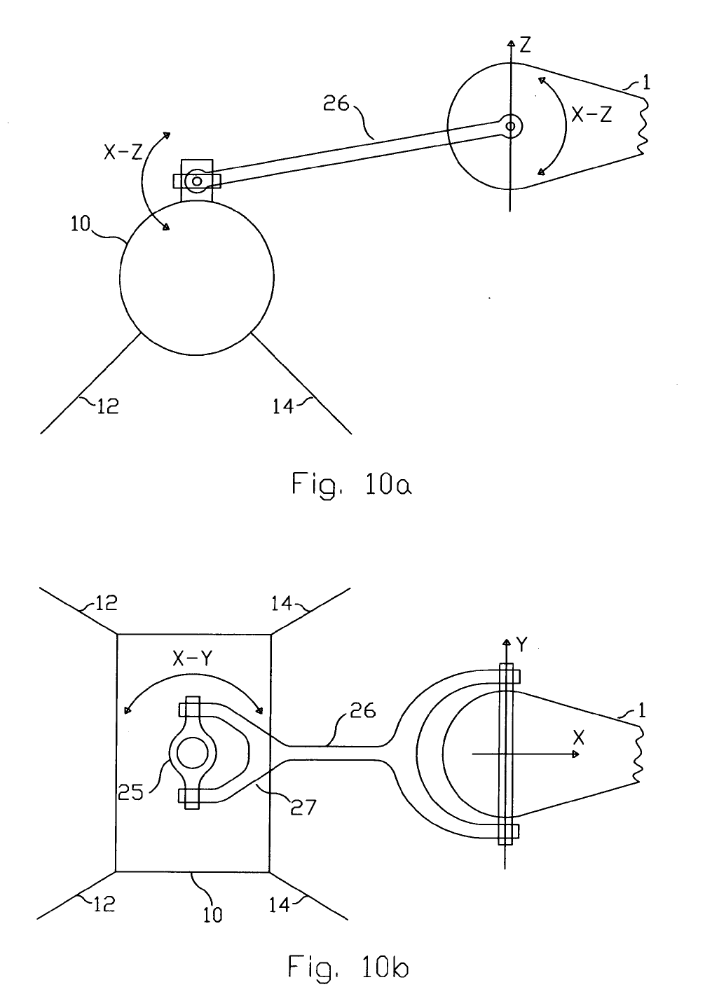

FIGS. 10a and 10b show a revised strut arrangement that incorporates a yoke connection to the turbine device.

A rigid connector has the advantage that it can be used to support and protect the power export umbilical. Two possible rigid connector strut solutions are shown in FIGS. 9a, 9b and 10a, 10b. The solution shown in FIGS. 9a and 9b can accommodate all six degrees of freedom of motion of the turbine device. The buoy (10) has a cross-head fitted (25) that can rotate in the x-y plane. The mooring strut (26) is attached to the buoy cross-head by a yoke (27) which allows rotation in the x-z plane. A similar arrangement exists for connecting the strut to the turbine device with cross-head (28) and yoke (29) allowing freedom of rotation in the x-y and x-z planes respectively. FIGS. 9a and 9b also shows an arrangement where the turbine device has freedom of rotation in the y-z plane (roll). This would only be incorporated if the turbine device incorporated a means to resist any moment induced by the turbine torque reaction such as a surface piercing strut to provide hydrostatic stability to resist turbine torque reaction effects from a horizontal axis turbine.

The solution shown in FIGS. 10a and 10b has reduced freedom of rotation at the turbine device end of the strut. The device is still free to rotate in the x-z plane (pitch) but is no longer free to rotate in the y-z plane (roll) or the x-y plane (yaw). However, the turbine device and strut combination is free to rotate in the x-y plane to allow the device to weathervane about the geofixed buoy 10. With the strut arrangement shown in FIG. 10 any out of balance torque reaction from a horizontal axis turbine will be transmitted to the buoy and resisted to a degree by the mooring system.

FIG. 11 shows how a power export umbilical is arranged to pass from the turbine device and is carried by the connector strut to the geofixed buoy from where it connects through a power transmission swivel and then descends to the seabed.

In the preferred embodiment of the mooring system illustrated in FIG. 11 the power export umbilical (30) is routed from the turbine device (1) along the connector strut (26) to the geofixed buoy (10). As the turbine device is free to rotate about the geofixed buoy (10) it is necessary to introduce a power export swivel (31) into the umbilical cable where it connects to the buoy. The power export umbilical is then typically routed from the geofixed buoy via a bend restrictor (32) where it exits the buoy to the seabed where it is connected to a seabed power export cable (33).

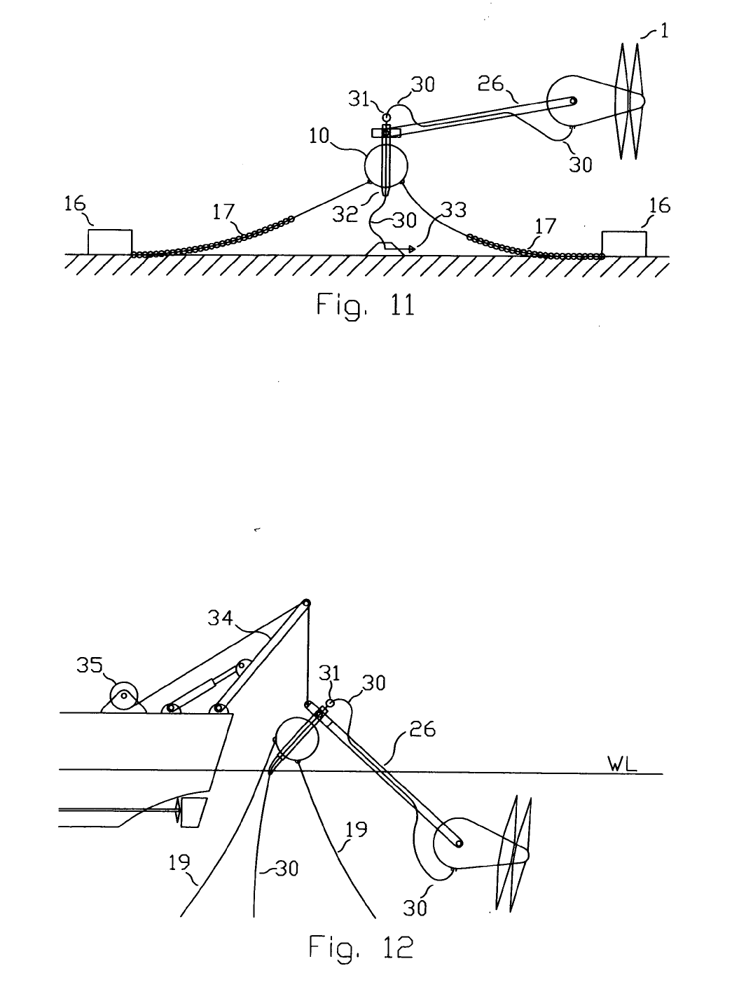

FIG. 12 shows how the submerged buoy is retrieved to above the waterline for attachment and disconnection of the mooring strut and power export umbilical.

The ability to disconnect the turbine device from its mooring is an important attribute as it allows maintenance activities to be carried out with the device removed from the hazardous fast flowing current. FIG. 12 shows how the submerged buoy can be recovered to the surface using a vessel with an A-frame (34) and winch (35), such that the connector strut (26) and umbilical cable (30) are accessible above the waterline for disconnection from the buoy. The catenary mooring solution is particularly appropriate as it allows the submerged buoy to be recovered to above the waterline without releasing the mooring tethers (19).

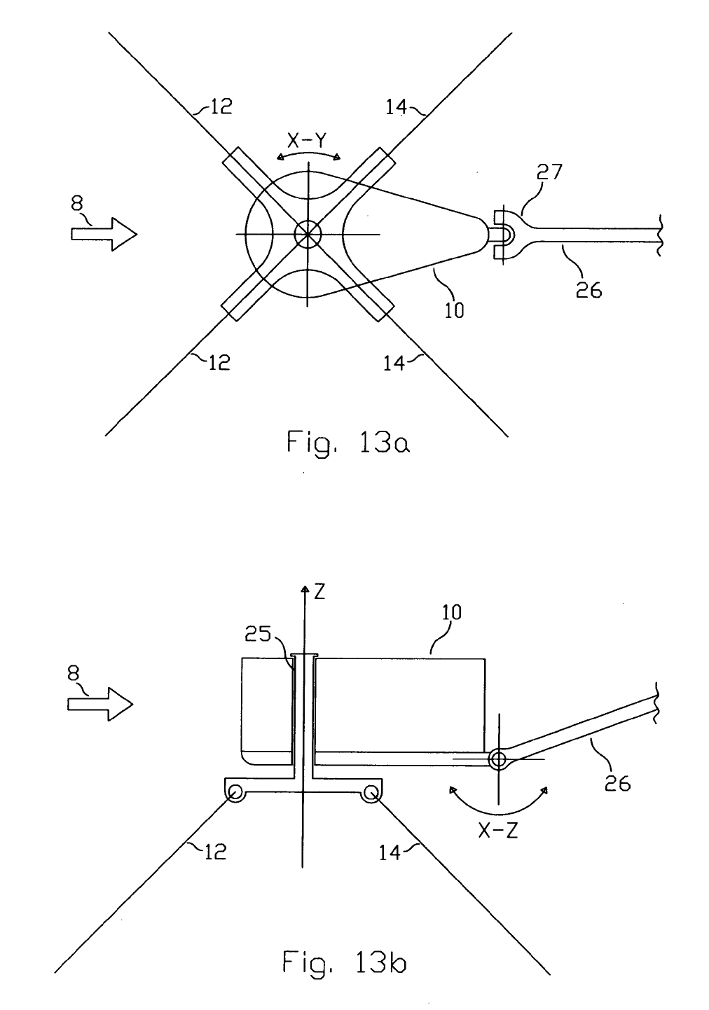

FIG. 13 shows how the main buoyancy element of the submerged buoy can be attached to the pivot so that it orientates itself with the device heading.

Further, if the main buoyancy element of the buoy can pivot around the geofixed mooring and is therefore always aligned with the flow, the buoyancy element can be made more streamlined in order to reduce the flow induce drag forces on the buoy, this arrangement being illustrated in FIG. 13(a) and (b).

Whilst the illustrated embodiments described above refer to a horizontal axis turbine device, a mooring system of the invention may be used with a vertical axis turbine device.

1. A turbine mooring system for mooring a turbine device adapted to extract power from a moving body of water, comprising
a buoyant body,
at least one mooring element arranged to moor the buoyant body to a substantially fixed object,
wherein in use a turbine is moored to the buoyant body and said buoyant body is submerged in the body of water.

2. A turbine mooring system according to claim 1, wherein said buoyant body is constrained by the at least one mooring element such that the said buoyant body lies in the body of water substantially removed from wave action in said body of water.

3. A turbine mooring system according to claim 1, wherein the buoyant body occupies a substantially fixed position with respect to the fixed object.

4. A turbine mooring system according to claim 1, wherein the position of the submerged buoyant body with respect to the fixed object and the surface of the body of water may be adjusted by changing the length of the mooring elements.

5. A turbine mooring system according to claim 1, wherein the buoyant body has a reserve of buoyancy sufficient to prevent a drag force exerted thereon by a turbine from causing the turbine to ground on the seabed.

6. A turbine mooring system including at least three mooring elements configured to spread moor the buoyant body to the fixed object.

7. A turbine mooring system according to claim 1, wherein the mooring elements comprise tension tethers or catenary mooring lines.

8. A turbine mooring system according to claim 6, wherein the mooring elements comprise tension tethers and the buoyant body has a reserve of buoyancy sufficient to subject a tensile load on all the tension tether mooring elements when the turbine imposes its maximum horizontal drag force on the buoyant body through its attachment to the buoyant body.

9. A turbine mooring system according to claim 1, including a swivel attached to the buoyant body, wherein the turbine device is attached to the swivel, said swivel providing for relative rotation of the turbine device with respect to the buoyant body.

10. A turbine mooring system according to claim 9, wherein the turbine device is attached to the swivel by a strut, and wherein the strut is attached to the turbine device and the swivel by elements which allow the strut and connected turbine device to move in the vertical plane.

11. A turbine mooring system according to claim 10, wherein the strut is attached to the turbine device and the swivel by elements which prevent the transmission of yaw, pitch or roll forces experienced by the turbine device to the buoyant body.

12. A turbine mooring system according to claim 10, wherein the roll force is transmitted from the turbine device through the strut to the buoyant body such that the mooring elements on the buoyant body provide roll restraint of the turbine device and visa versa.

13. A turbine mooring system according to claim 1, further comprising a power export umbilical, and wherein the power export umbilical includes a power export swivel.

14. A turbine mooring system according to claim 1, wherein the buoyant body includes a buoyant element and a support to which the buoyant element is attached, wherein the support is attachable to the mooring elements of the system.

15. A turbine mooring system according to claim 14, wherein the buoyant element is mounted on the support to swivel thereabout.

16. A turbine mooring system according to claim 15, wherein the buoyant element is streamlined.

17. A combination comprising at least one turbine device moored to at least one turbine mooring system as claimed in claim 1.

18. A method of extracting kinetic energy from a body of water comprising the steps of:
i) mooring at least one turbine device to the bed of the body of water or an object substantially fixed with respect to said bed,
ii) exporting power generated by the turbine device to at least one power consuming device.

19. (canceled)
